(19) United States
(12) Patent Application Publication
(10) Pub. No.: US 2009/0278503 A1
(43) Pub. Date: Nov. 12, 2009

(54) THIN-FILM BATTERY EQUIPMENT

(75) Inventors: Michael J. Hundt, Double Oak, TX (US); Frank J. Sigmund, Coppell, TX (US)

Correspondence Address: STMICROELECTRONICS, INC., MAIL STATION 2346, 1310 ELECTRONICS DRIVE, CARROLLTON, TX, 75006, US

(73) Assignee: STMICROELECTRONICS, INC., Carrollton, TX (US)

(21) Appl. No.: 12/506,184

(22) Filed: Jul. 20, 2009

Related U.S. Application Data
(62) Division of application No. 10/284,424, filed on Oct. 29, 2002.

(51) Int. Cl. H02J 7/04; H01M 6/02

(52) U.S. Cl. 320/150; 29/623.5; 977/773

(57) ABSTRACT

In one aspect, a method of making an apparatus includes forming a thin-film battery; affixing a device to the thin-film battery while the thin-film battery is in a substantially discharged state; and subjecting the thin-film battery to a high temperature that exceeds a temperature rating of the thin film battery before the thin-film battery is charged.

### CROSS-REFERENCE TO RELATED APPLICATION

This application is a divisional of U.S. patent application Ser. No. 10/284,424, filed Oct. 29, 2002, now pending, entitled “Thin-Film Battery Equipment,” which is incorporated herein by reference in its entirety.

### BACKGROUND OF THE APPLICATION

1. Field of the Application

The present application relates to equipment that incorporates electronic devices that utilize battery power.

2. Description of the Related Art

An electronic device is a machine that performs work using power supplied, at least in part, in the form of the flow of electrons. A battery is a device that consists of one or more cells (a cell is a device that converts a store of chemical energy into electrical energy) that are connected to act as a source of electric power. A rechargeable battery is a device whose one or more cells can be substantially reenergized once the store of chemical energy in the rechargeable battery has been partially or completely depleted.

An electronic device which utilizes battery power is one in which the electronic power supplied to the device comes at least in part from a battery. One type of electronic device that utilizes battery power is an integrated circuit, such as a memory circuit, a DC-DC converter, or a processor.

A variety of equipment incorporates electronic devices that utilize batteries. Examples of such equipment are portable computers, portable computer peripherals, personal digital assistants (PDAs), cellular phones, and cameras.

### BRIEF DESCRIPTION OF THE SEVERAL VIEWS OF THE DRAWINGS

FIG. 1 shows a side-plan view of apparatus 100.

FIG. 2 shows an illustrative example of thin-film battery 102 used in one embodiment of the present invention.

FIG. 3 shows one implementation of surface 104 in one embodiment of the present invention.

FIG. 4 depicts a side-plan view of a structure that may be used to create an implementation of surface 104 using substrate 108.

FIGS. 5A-5C illustrate side-plan views of structures representative of a method for constructing, at a substantially high temperature, a device having a thin-film battery.

The use of the same symbols in different drawings typically indicates similar or identical items.

### DETAILED DESCRIPTION OF THE APPLICATION

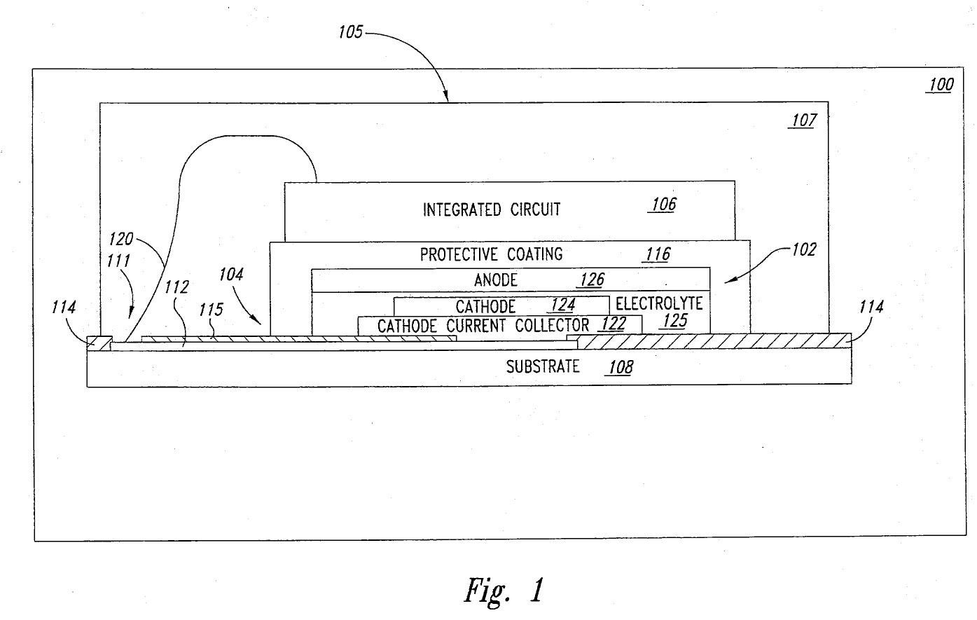

FIG. 1 shows a side-plan view of apparatus 100. Apparatus 100 has incorporated within it an integrated circuit and battery unit 105. The circuit unit 105 includes a thin-film battery 102 affixed to surface 104 and an integrated circuit 106 overlying the battery 102.

In a typical embodiment of the present invention, apparatus 100 is an electronic system that has circuitry in need of battery-supplied electric power, such as a wireless system or a computer system. Examples of such wireless systems include but are not limited to wireless phones, wireless handheld computers, wireless modems, wireless email units, and wireless Global Positioning System locators. Examples of such computer systems include but are not limited to handheld computer systems, personal computer systems, workstation computer systems, minicomputer systems, and mainframe computer systems.

In many embodiments, the apparatus 100 is of a type that requires extremely low power for operation or low power for retention of data. Typically, the battery 102 provides 5 volts, or alternatively 3.6 volts, depending on the application and integrated circuit used. The integrated circuit may be of the type used in a smart card which has very low requirements for data retention. The apparatus may also be of a low power memory type, such as an SRAM, a tag RAM or some other data storage device which is desired to remain programmable but have local battery power capability. In many applications, such as a wireless phone, a modem, a GPS system or the like, the battery 102 will be a backup battery for maintaining system operation in the even main power supply fails. Thus, the battery 102 may be used in combination with other power supply systems if the apparatus 100 is of the type which consumes large amounts of power.

In such combinations, the battery 102 is the primary power storage device and may, in some instances be the sole source of battery storage or, potentially the sole source of electrical power during certain times of operation of the integrated circuit 106 and of the apparatus 100. Alternatively, the battery 102 may be charged during normal operation of the device and then be used to power only certain components within the overall system 100, such as the integrated circuit 106 while other portions of the circuit obtain their power from different sources. In a typical embodiment of the present invention, surface 104 is a surface formed from one or more structures used in a semiconductor device. Examples of such surfaces include but are not limited to surfaces of semiconductor package substrates, surfaces of semiconductor substrates, surfaces of integrated circuit packages, and surfaces formed as a combination of other surfaces. For example, FIG. 1 shows surface 104 as a non-flat surface made up of a conductive trace 112 and dielectric layers 114 and 115. In addition, in various other embodiments of the present invention surface 104 may be a flexible, rigid, flat, or irregular surface.

Continuing to refer to FIG. 1, device 106 is affixed to thin-film battery 102 via coating 116. In some embodiments of the present invention, device 106 is an integrated circuit, and in such embodiments the substrate of the integrated circuit is affixed to thin-film battery 102. In other embodiments of the present invention, device 106 is other of various electrical circuit elements well known to those of ordinary skill in the art, such as passive electrical circuit elements or active electrical circuit elements. Examples of passive electrical circuit elements include but are not limited to capacitors, inductors, and resistors. Examples of active electrical circuit elements include but are not limited to operational amplifiers, power supplies, DC-DC converters, and batteries. Examples of coating 116 are insulating epoxy and encapsulant material.

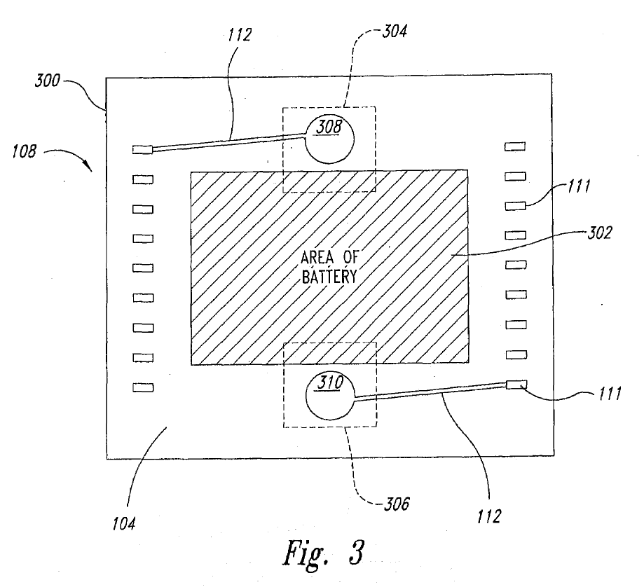

Continuing to refer to FIG. 1, circuitry of device 106 is electrically connected with thin-film battery 102. Specifically, circuitry of device 106 is electrically connected with bonding wire 120. Bonding wire 120 is electrically connected with bonding pad 111. Bonding pad 111 is electrically connected with conductive trace 112. Conductive trace 112 is electrically connected with cathode current collector 122. Cathode current collector 122 is in direct contact with cathode 124. Device 106 is similarly connected with lithium anode 126 of thin-film battery 102 via similar bonding wires, bonding pads, conductive traces, and an anode current collector, as is clear from FIG. 3. Electrolyte 125 resides between and completely isolates cathode 124 from direct contact with lithium anode 126.

Continuing to refer to FIG. 1, encapsulant 107 encapsulates device 106 and thin-film battery 102. Encapsulant 107 may be formed by virtually any encapsulant process well known to those of ordinary skill in the art.

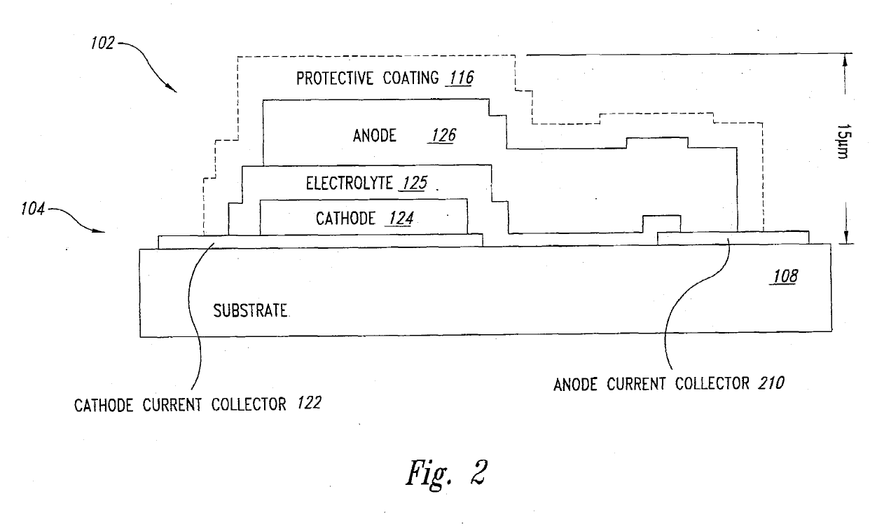

Referring now to FIG. 2, shown is an illustrative example of thin-film battery 102 used in one embodiment of the present invention. In one embodiment of the present invention, thin-film battery 102 is a type of lithium ion battery having a height of about 15 μm. In one embodiment, when the device 106 is an integrated circuit, the height of device 106 is about 250 μm. The device 106 and battery 102 are not shown to scale in FIG. 1, hence the battery 102 is approximately 10 times thinner than the device 106. The unit 105 is also not drawn to scale with the entire apparatus 100, since the apparatus 100 may be 10 times larger than the unit 105. Examples of lithium batteries are those with crystalline LiCoO₂ cathodes, nanocrystalline LiMn₂O₄ cathodes, crystalline LiMn₂O₄ cathodes. The battery 102 may also be a lithium-ion battery with crystalline LiCoO₂ cathode, or lithium phosphorous oxynitride (“Li-ion”) electrolyte. It may have a lithium anode or a lithium-ion anode, such as SiTON, SnNₓ or InNₓ. It may also be a “lithium-free” thin film battery that is fabricated with only an anode current collector and the protective overlay. Upon the initial charge of the battery, a metallic lithium anode is plated in situ at the current collector. The lithium anode can be plated and stripped reversibly. One advantageous feature of the “lithium-free” thin film battery is the capacity and discharge rates are as high as batteries with an evaporated lithium anode. The cells can be cycled thousands of times. The newly fabricated battery can be heated to 250° C.

Continuing to refer to FIG. 2, thin-film battery 102 is formed on surface 104 and is composed of cathode 124, electrolyte 125, lithium anode 126, and protective coating 116. The protective coating 116 is optional and may not be present in all embodiments.

Cathode 124 and lithium anode 126 respectively electrically connect with cathode current collector 122 and anode current collector 210. In one embodiment, cathode current collector 122 and anode current collector 210 are formed contiguous with their respective connections of thin-film battery 102. In another embodiment, cathode current collector 122 and anode current collector 210 form a part of surface 104 such that when thin-film battery 102 is placed on surface 104 (see FIG. 3), cathode current collector 122 and anode current collector 210 respectively align with their respective connections on thin-film battery 102. In yet another embodiment the collectors are formed on different structures (e.g., cathode current collector 122 is formed contiguous with its respective connection of thin-film battery 102 and anode current collector 210 forms a part of surface 104). In certain implementations, thin-film battery 102 is formed as part of a process of constructing a semiconductor device package.

In one implementation, thin-film battery 102 is a lithium anode battery which is formed in a substantially discharged state such that the lithium anode forms a compound rather than pure lithium thus permitting the battery to be subjected to high temperatures. This may also be used for the lithium cathode as well. The temperature the unit experiences during production can thus be quite high and still provide stable charging and discharging. The temperature is kept below that temperature at which the discharged battery is damaged.

With reference now to FIG. 3, shown is one implementation of surface 104 used in one embodiment of the present invention. Depicted is a top-plan view of substrate 108 upon which is inscribed area 302 which forms the expected footprint of thin-film battery 102 on surface 104. Also inscribed on substrate 108 are anode (+) current collector footprint 306, and cathode (−) current collector footprint 304. Metallized areas 310 and 308 are positioned to respectively mate with anode current collector 210 and cathode current collector 122 when anode current collector 210 and cathode current collector 122 are placed within the confines of anode (+) current collector footprint 306 and cathode (−) current collector footprint 304. Metallized areas 310 and 308 are electrically connected with conductive traces 112. Conductive traces 112 are electrically connected with wire bonding sites 111.

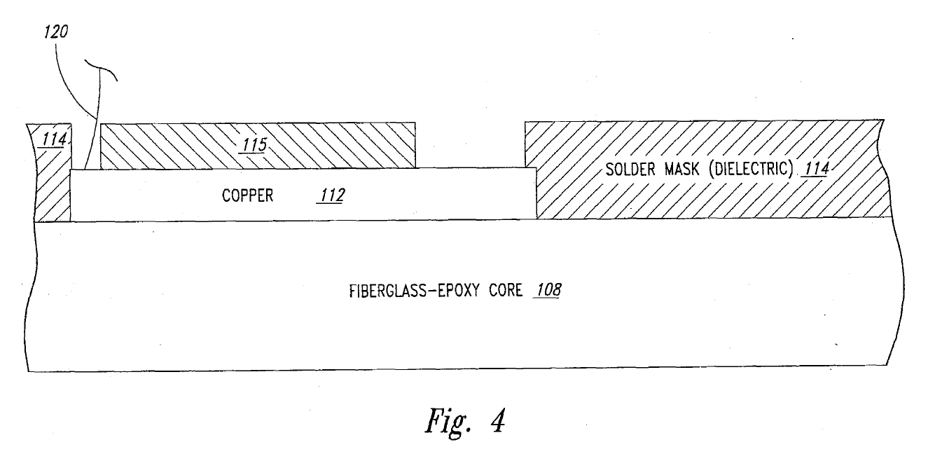

Referring now to FIG. 4, depicted is a side-plan view of a structure that may be used to create an implementation of surface 104 using substrate 108. Illustrated is that in one implementation substrate 108 is composed of a fiberglass-epoxy core. Copper metal layer 112 is deposited on fiberglass-epoxy core 108, and then etched to created conductive traces (e.g., conductive traces 112), bonding pads (e.g., bonding pads 111), and metallized areas (e.g., metallized areas 308, 310). Thereafter, in one embodiment, dielectric layer 114 is created via a solder masking operation thereby forming an implementation of surface 104.

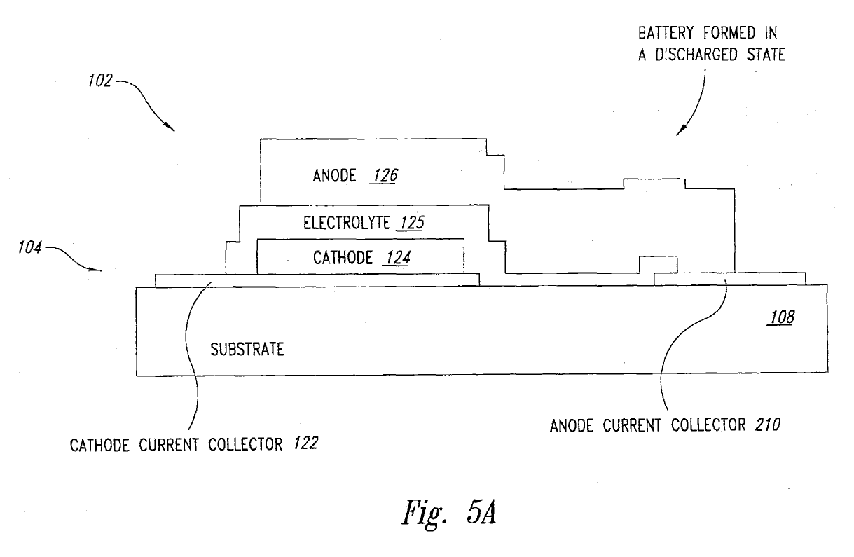

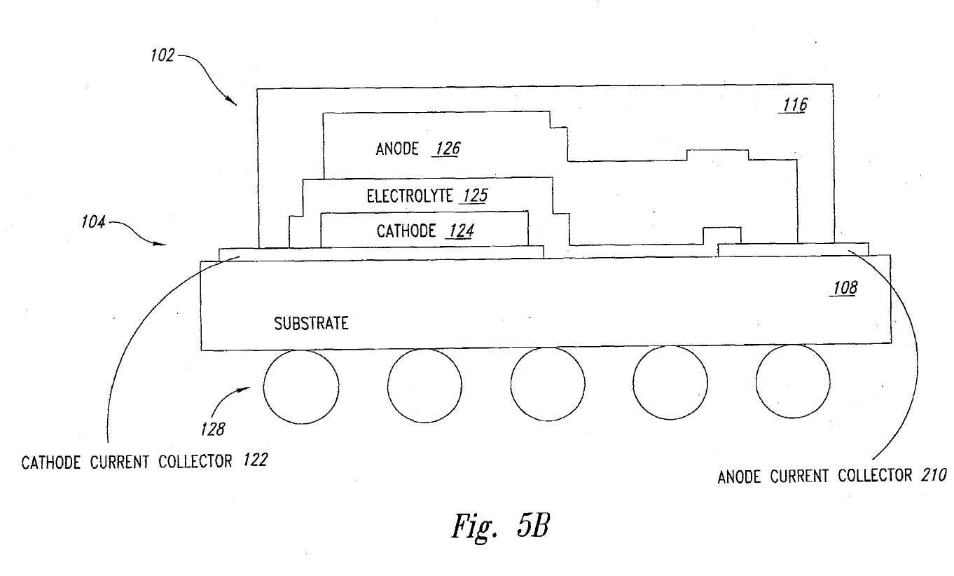

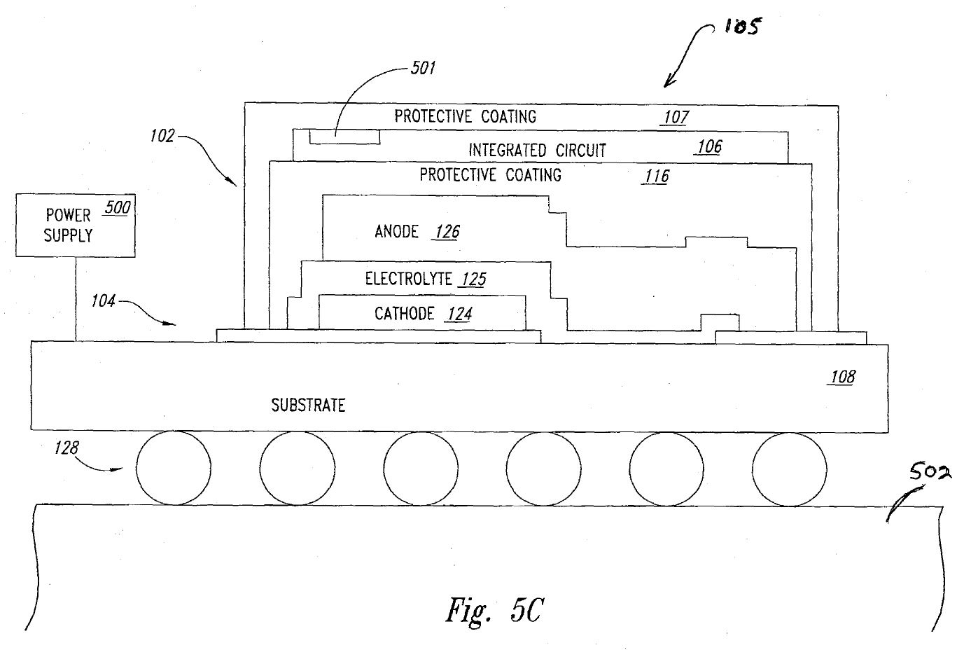

With reference now to FIGS. 5A-5C, illustrated are side-plan views of structures representative of a method for constructing, at a substantially high temperature, a device having a thin-film battery. Referring now to FIG. 5A, shown is thin-film battery 102 formed, in a substantially discharged state, proximate to surface 104. An example of forming a thin-film battery 102 in a substantially discharged state, proximate to surface 104, is forming anode 126 and cathode 124 of a thin-film battery such that during a subsequent battery charging, lithium provided by cathode 124 (typically LiCoO₂) reacts with anode 126 material producing conductive nanocrystalline Li—Sn alloy particles embedded in an amorphous matrix. Another example of forming a thin-film battery 102 in a substantially discharged state, proximate to surface 104, is forming a lithium anode of a thin-film lithium battery in a lithium-composite state. Another example of forming a thin-film battery in a substantially discharged state, proximate to surface 104, is forming a lithium anode of a thin-film lithium battery in an amorphous lithium state.

With reference now to FIG. 5B, depicted is attaching structures to thin-film battery 102, where the attaching is done at a temperature greater than or equal to that necessary to achieve the attaching but less than that which would substantially damage thin-film battery 102 in the substantially-discharged state. An example of attaching a structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt epoxy resin, such as would be done if conductive epoxy resin (not shown) were used to affix thin-film battery 102 to substrate 108. Another example of attaching structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt solder (e.g., a temperature of 250 degrees Centigrade), such as solder (not shown) used to affix ball grid connector 128 to substrate 108. Another example of attaching a structure to thin-film battery 102 at a temperature greater than or equal to that necessary to achieve the attaching, but less than that which would substantially damage thin-film battery 102 in the substantially-discharged state, is applying heat proximate to surface 104 at a temperature greater than or equal to that necessary to partially melt a portion of ball grid connector 128.

There are several thin-film battery formation processes, and batteries, that can be utilized with the described high-heat attaching. Examples of such thin-film battery formation processes, and batteries, are those described on the Oak Ridge National Laboratory web site at, for example the URL http://www.ssd.ornl.gov/programs/BatteryWeb/, the content of such web site being hereby incorporated by reference in its entirety.

Referring now to FIG. 5C, illustrated is battery charger 500 charging thin-film battery 102, where thin-film battery 102 was previously formed and heated in a partially discharged state, such as shown and described in relation to FIGS. 5A and 5B. The charging of thin film batter 102 occurs subsequent to forming thin-film battery 102 in the substantially discharged state. By forming thin-film battery 102 in a partially-discharged state, applying high heat to thin-film battery 102 while is in a partially discharge state, and thereafter charging thin-film battery 102, it has been found that thin-film battery 102 can be employed in high heat manufacturing processes which heretofore could not employ thin-film batteries. In some embodiments, subsequent to thin-film battery 102 being formed in a substantially discharged state, the thin-film battery 102 is subjected to multiple high-heat processes, and thereafter thin-film battery 102 is charged (i.e., subsequent to the last high-heat process). Forming thin-film battery 102 in a substantially discharged state proves particularly useful when used with the other subject matter disclosed herein.

The foregoing described embodiments depict different components contained within, or connected with, different other components. It is to be understood that such depicted architectures are merely exemplary, and that many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the scope of this invention. Furthermore, it is to be understood that the invention is solely defined by the appended claims. It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

1. A method of making an apparatus, the method comprising:
forming a thin-film battery;
affixing a device to the thin-film battery while the thin-film battery is in a substantially discharged state; and
subjecting the thin-film battery to a high temperature that exceeds an operating temperature rating of the thin film battery while the thin-film battery is in the discharged state.

2. The method of claim 1, wherein forming a thin-film battery comprises depositing at least one of an anode, an electrolyte, and a cathode of the thin-film battery.

3. The method of claim 1, wherein forming a thin-film battery comprises depositing a lithium anode of the thin-film battery proximate to at least one surface.

4. The method of claim 1, wherein forming a thin-film battery comprises forming at least one of an anode current collector conductive region and a cathode current collector conductive region.

5. The method of claim 4, wherein forming at least one of an anode current collector conductive region and a cathode current collector conductive region comprises patterning a dielectric overlying a conductive material on a semiconductor package substrate.

6. The method of claim 1, wherein forming a thin-film battery comprises forming an anode and a lithium-containing cathode of the thin-film battery such that, during a subsequent battery charging, the lithium of the cathode reacts with materials of the anode to produce conductive nanocrystalline Li—Sn alloy particles embedded in an amorphous matrix.

7. The method of claim 1, wherein forming a thin-film battery comprises forming a lithium anode of a thin-film lithium battery in a lithium-composite state.

8. The method of claim 1, wherein forming a thin-film battery comprises forming a lithium anode of a thin-film lithium battery in an amorphous lithium state.

9. The method of claim 1, wherein affixing a device to the thin-film battery comprises affixing an integrated circuit to at least one surface of the thin-film battery.

10. The method of claim 1, wherein affixing a device to the thin-film battery comprises affixing the device to the thin-film battery at a first temperature greater than or equal to a second temperature necessary to affix the device to the thin-film battery but less than a temperature threshold above which the thin-film battery is damaged.

11. The method of claim 1 further comprising:
charging the thin-film battery after the thin-film battery is subjected to the high temperature.
